(19) United States
(12) Patent Application Publication
(10) Pub. No.: US 2015/0096052 A1
(43) Pub. Date: Apr. 2, 2015

(54) Children's Online Personal Info Privacy Protection Service

(71) Applicant: ALCATEL-LUCENT USA INC., Murray Hill, NJ (US)

(72) Inventors: Suzann Hua, Lisle, IL (US); Yigang Cai, Naperville, IL (US)

(73) Assignee: ALCATEL-LUCENT USA INC., Murray Hill, NJ (US)

(21) Appl. No.: 14/039,316

(22) Filed: Sep. 27, 2013

(51) Int. Cl. H04L 29/06

(52) U.S. Cl. CPC H04L 63/0227
USPC 726/28

(57) ABSTRACT

A children's online personal information privacy protection service is disclosed, implemented in one embodiment within a Home Subscriber Server (HSS) of an IMS communication network. The HSS maintains service profiles including child user flags identifying which users are child users; and the service profiles for child users includes items of child user personal information content and access authorization data. The access authorization data is adjustable based on parental consent to allow or disallow access to certain network entities. When queried for information content by a network entity, the HSS consults the child user flag to determine whether the query relates to a child user, and if so, controls access to the information content based on the access authorization data.

### FIELD OF THE INVENTION

This invention relates generally to communication systems and, more particularly to a service feature for protecting the privacy of personal information associated with child users of web or online services.

### BACKGROUND OF THE INVENTION

The Internet is a well-known communication system in which users can access a myriad of websites or online services to perform online activities or transactions. Increasingly, users of the Internet include child users and there are many network entities (e.g., websites and online services, including mobile apps) that are directed to (or if not directed to them, are accessible by) children. Because children are vulnerable to online predators, predatory business practices and the like, legislative controls have been enacted to protect the privacy and safety of child users online. In the United States, the Children's Online Privacy Protection Act (“COPPA”) applies to the online collection of personal information from children under age 13, and requires that certain operators of commercial website or online services that may encounter child user personal information content must obtain verifiable parental consent before collecting, using or disclosing such information. However, under existing standards and practices, online vendors/operators may find it difficult to comply with the COPPA, or other like-minded child privacy and safety controls, because there is not an efficient way for them to determine which users are child users, and hence which user information content is controlled by the COPPA, not to mention obtaining and/or validating parental consent for the collection, use or disclosure of any such controlled information content.

### SUMMARY OF THE INVENTION

This problem is addressed and a technical advance is achieved in the art by a children's online personal information privacy protection service, implemented in one embodiment within a subscriber database platform of a communication network (e.g., a Home Subscriber Server (HSS) of an IMS communication network). The HSS maintains service profiles for users, including child users. The service profiles include child user flags identifying which users are child users; and the service profiles for child users includes items of child user information content (“child-specific information content”) and access authorization data. The access authorization data includes, in one embodiment, a list of network entities having obtained parental consent to access the child-specific information content associated with certain child users. Optionally, the access authorization data may identify certain network entities having default authorization to access the child specific-information content but which default authorization may be removed by the childs' parent(s). When the HSS receives access queries from network entities (i.e., for access to information content of a designated user), it consults the child user flag to determine whether the access query relates to a child user. If it does, the HSS consults the access authorization data associated with the child user and controls access (i.e., grants or denies access) to the child-specific information content of the user based on the access authorization data. In such manner, access of network entities to information content of child users is controlled, and adjustable based on parental consent, in compliance with legislative controls.

In one embodiment, there is provided a method performed by a subscriber database platform (e.g., a HSS of an IMS network). The HSS identifies one or more users, including a number of child users; and maintains service profiles for the one or more users. The service profiles include a child user flag identifying the child users of the one or more users; and the service profiles of the child users further include: one or more items of child-specific information content; and access authorization data associated with the child-specific information content. The HSS controls access to the child-specific information content of respective child users based on the access authorization data. The HSS receives an access query initiated by a requesting network entity corresponding to a designated user and consults the child user flag to determine whether the designated user is a child user. If the designated user is a child user, the HSS consults the access authorization data to determine if the requesting network entity is authorized to access the child-specific information content. If the requesting network entity is authorized, the HSS grants access to one or more instances of the child-specific information content; otherwise if the requesting network entity is not authorized, the HSS denies access to the child-specific information content.

In one embodiment, there is provided an apparatus comprising a processor and memory. The processor is operably coupled to the memory and configured to identify one or more users, including a number of child users; and maintain service profiles for the one or more users. The service profiles include a child user flag identifying the child users of the one or more users; and the service profiles of the child users further include: one or more items of child-specific information content; and access authorization data associated with the child-specific information content. The processor controls access to the child-specific information content of respective child users based on the access authorization data. The processor receives an access query initiated by a requesting network entity corresponding to a designated user and consults the child user flag to determine whether the designated user is a child user. If the designated user is a child user, the processor consults the access authorization data to determine if the requesting network entity is authorized to access the child-specific information content. If the requesting network entity is authorized, the processor grants access to one or more instances of the child-specific information content; otherwise if the requesting network entity is not authorized, the processor denies access to the child-specific information content.

### BRIEF DESCRIPTION OF THE DRAWINGS

The foregoing and other advantages of the invention will become apparent upon reading the following detailed description and upon reference to the drawings in which:

FIG. 1 illustrates an IMS network in an exemplary embodiment of the invention;

FIG. 2 is a block diagram of a Home Subscriber Server (HSS) of the IMS Network in an exemplary embodiment of the invention;

FIG. 3 is a flowchart showing steps performed by the HSS for provisioning a children's online personal information privacy protection service in an exemplary embodiment of the invention; and

FIG. 4 is a flowchart showing steps performed by the HSS for controlling access of network entities to child-specific information content in an exemplary embodiment of the invention.

### DESCRIPTION OF THE PREFERRED EMBODIMENT(S)

FIG. 1 illustrates a communication network 100 for providing a children's online personal information privacy protection service in an exemplary embodiment of the invention. Communication network 100 comprises a serving network 102 adapted to serve various customers 104 (two shown, representing a child user and the child's parent). In the embodiment of FIG. 1, the serving network comprises an IMS network. As set forth in the 3^{rd} Generation Partnership Project (3GPP) or 3GPP2, IMS provides a common core network having access-agnostic network architecture for converged networks. Service providers are using this architecture in next-generation network evolution to provide multimedia services to mobile users (and also fixed access users). IMS uses IP (Internet Protocol), and more specifically uses Session Initiation Protocol (SIP) as the call control protocol. Generally, the serving network 102 may comprise, without limitation, an IMS network, a wireless network (e.g., CDMA-based or GSM-based network), a circuit-switched network or a packet- based network.

As shown, the elements of the IMS network 102 include a CSCF 106 (Call Session Control Function), HSS 108 (Home Subscriber Server), OSS 110 (Operating Support Server) and an AS 112 (Application Server). The IMS network 102 is also operably connected to an external network (as shown, the Internet 114) containing an AS 116 (Application Server).

The CSCF 106 comprises any server, platform or system operable to provide

IMS Session Control for users 104 accessing the IMS network 102, which includes managing user registrations, and exchanging SIP signaling messages with other IMS elements and/or connected application server(s) coincident to an IMS call session. The users 104 may access the IMS network 102 with UE, or user equipment (not shown) comprising for example, smart phones, tablets, laptop or desktop computers.

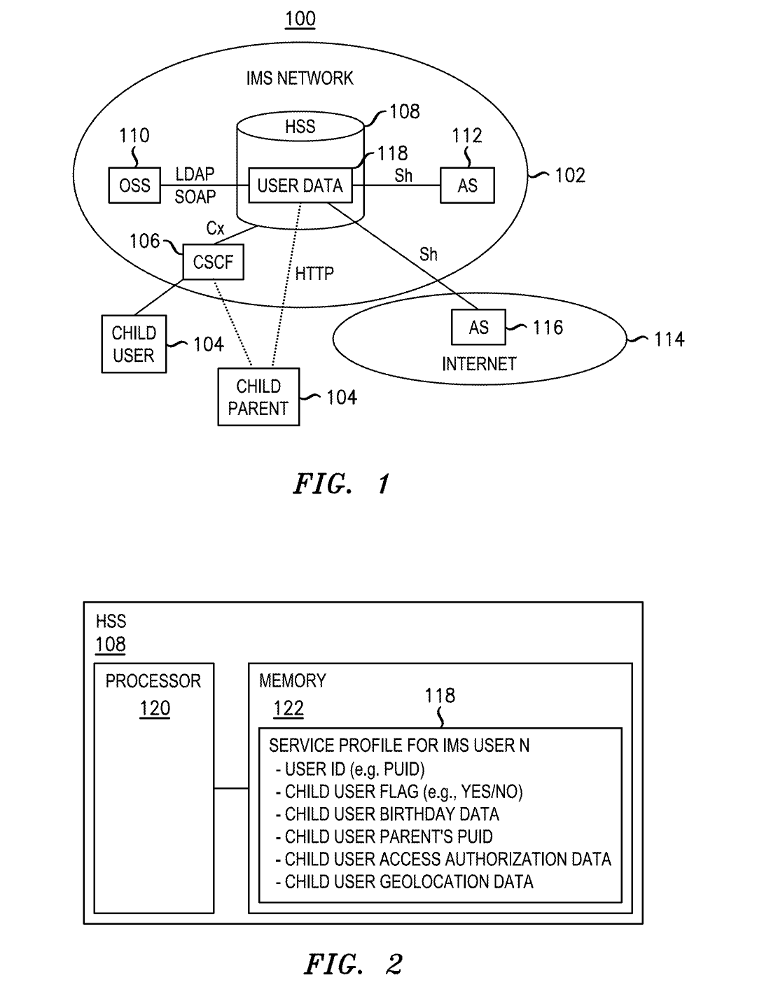

The HSS 108 comprises any server, platform or system operable to store IMS user data 118. In one embodiment, the HSS maintains user data 118 in the form of service profiles indexed to various IMS users, which may include child users. As will be described in greater detail in relation to FIG. 2, the service profiles include a child user flag identifying which users are child users; and includes, for child users, items of child-specific information content and access authorization data associated with the child-specific information content. The HSS controls access to the child-specific information content based on the access authorization data. As shown, the interface between the HSS and CSCF is known as the Cx interface and the interface between the HSS and AS 112 and AS 116 are known as Sh interfaces. The link between the HSS and OSS comprises an LDAP or SOAP protocol; and the link between the HSS and the parent user 104 comprises an HTTP protocol.

The OSS 110 comprises any server, platform or system providing operating support functions. For example, the OSS 110 may provide operating support for billing, statistical evaluation purposes or the like.

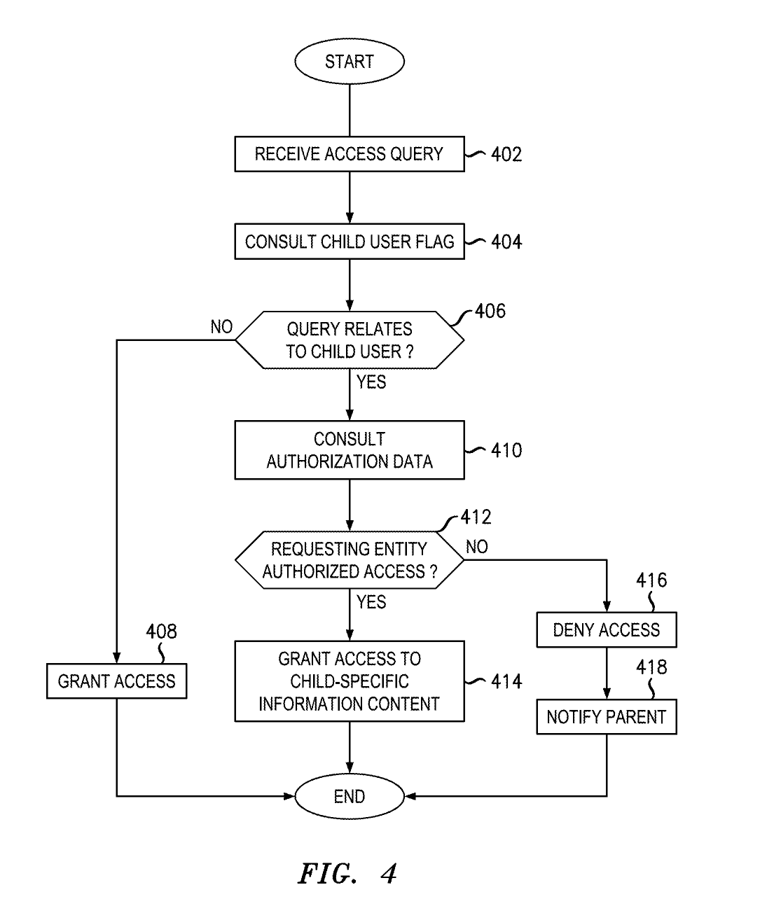

The AS 112 and AS 116 comprise network entities, including for example and without limitation, servers, platforms or systems that host websites or online services that are accessible to IMS users 104, and which may periodically seek to access information content associated with IMS users. The AS 112 resides within the IMS core network 102 and in one embodiment, may be considered by default to be authorized to access child-specific information content (although default authorization may be removed by a parent). The AS 116 resides outside of the IMS core network and by default is not authorized to access child-specific information content (although authorization may be granted by a parent). The AS 112 and AS 116 need not know which users are child users, hence which users possess information content (“child-specific information content”) that is subject to COPPA or other regulatory controls, and may or may not know whether parental consent has been obtained to access the child-specific information content. Rather, according to embodiments described herein, the HSS maintains service profiles that identifies which users are child users, and maintains child-specific information content and access authorization data associated with the child users. Upon receiving an access query from an AS, the HSS determines whether it relates to a child user, and if so, controls access (i.e., grants or denies access to the AS) to the child-specific information content based on the access authorization data, as will be described in greater detail in relation to FIG. 4.

As will be appreciated, each of the elements of FIG. 1 are functional elements that may reside individually or collectively in one or more physical structures or may be implemented in software. Further, the elements, and the links between elements may take different forms depending on the network topology of the serving network 102. For example, in a wireless network, the function of the CSCF 112 may be accomplished by a switching element such as a Mobile Switching Center (MSC) and the functionality of the HSS 108 may be accomplished by a Home Location Register (HLR).

FIG. 2 shows a block diagram of a Home Subscriber Server (HSS) 108 that may be implemented in the IMS network 102 of FIG. 1 to provide a children's online personal information privacy protection service according to embodiments of the present invention. The HSS 108 includes a processor 120 and memory 122 for effecting transactions with the AS 112, 114 or other IMS network entities to execute children's online privacy protection features.

Generally, the processor 120 is operable to execute program code stored in memory 122 (e.g., including but not limited to operating system firmware/software and application software) to execute children's online privacy protection features; and the memory 122 is operable to store IMS user data 118 in the form of service profiles indexed to various IMS users, which may include child users. As shown, a service profile for exemplary user N includes a user ID (e.g., Public User ID (PUID)) and a child user flag (e.g., yes/no). The service profile further includes, for child users, items of child-specific information content (as shown, child user birthday data, child user parent's PUID and child user geolocation data) and access authorization data. In one embodiment, the access authorization data comprises a “whitelist,” or list of authorized network entities (e.g., server names, domain names or the like) indexed to particular child users, for which parental consent has been obtained for the listed network entities to collect or maintain child-specific information content associated with those users, or for which default access has been granted unless authorization is removed by the childs' parent(s). Alternatively or additionally, the access authorization data may comprise a “blacklist” identifying disallowed network entities corresponding to particular child users. As will be appreciated, the service profile may include additional information not shown in FIG. 2, for child users or other than child users.

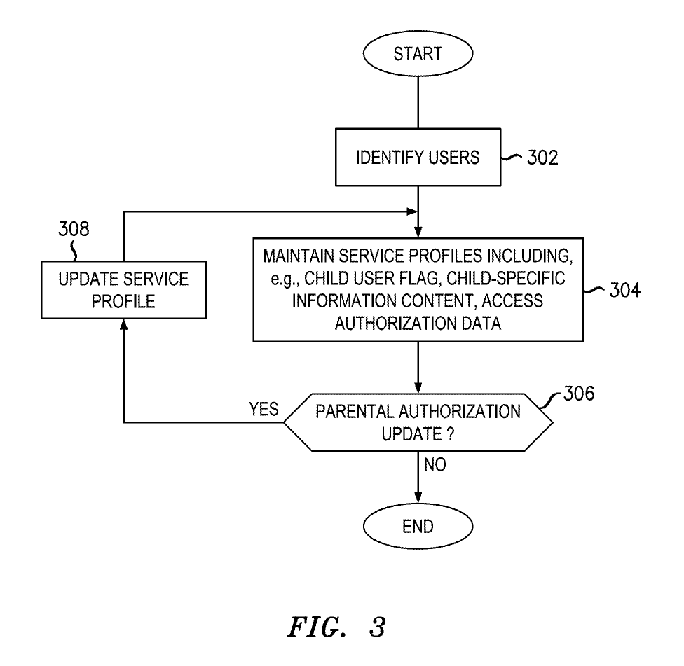

FIG. 3 is a flowchart showing steps performed by the HSS for provisioning a children's online personal information privacy protection service in an exemplary embodiment of the invention. The method is implemented, in one embodiment, by the processor 120 and/or memory 122 of the HSS 108. For convenience, the steps of FIG. 3 will be described generally as performed by the HSS 108. The steps of FIG. 3 need not be performed in the order shown.

At step 302, the HSS 108 identifies one or more users, indexed to respective user IDs (e.g., PUIDs). The users are contemplated to include a number of child users (e.g., defining users meeting a designated child age criteria, such as 13 years of age or younger under criteria of the Children's Online Privacy Protection Act (“COPPA”)) as well as users other than child users. In one embodiment, the HSS identifies which users are child users and maintains a child user “flag” indicator indexed with respective user IDs, indicating “yes,” for example, for those meeting the designated child age criteria and “no” for those not meeting (or no longer meeting) the designated age criteria. In one embodiment, child users are identified by maintaining birthday data of the users, determining respective user ages based on the birthday data, and determining which users have ages that satisfy the designated child age criteria. In one embodiment, the birthday data is stored in encrypted form and can only be accessed by HSS service logic.

At step 304, the HSS provisions and maintains service profiles for respective users. For example, as described in relation to FIG. 2, the service profiles may include a user ID (e.g., Public User ID (PUID)) and a child user flag (e.g., yes/no, indicating whether each respective user is or is not a child user). For those identified as child users, the service profile further includes items of child-specific information content (for example, child user name, birthday data, child user parent's PUID and child user geolocation data) and access authorization data. The child user parent's PUID is used, in one embodiment, to contact the child's parent, where appropriate to obtain parental consent for use or sharing of the child's information. As described in relation to FIG. 2, the access authorization data comprises a “whitelist,” or list of authorized network entities (e.g., server names, domain names or the like) indexed to particular child users, for which parental consent has been obtained for the listed network entities to collect or maintain child-specific information content associated with those users, or for which default access has been granted unless removed by the childs' parent(s). In one embodiment, the access authorization data is accessible and updatable by the child's parent (i.e., the parent PUID stored for the child user) via web interface or SMS interface.

At step 306, the HSS may periodically receive parental updates to the access authorization data associated with respective child users. For example, parents may access the whitelist to add or remove network entities from the whitelist associated with their child. If an update is received, the HSS updates the service profile at step 308 and returns to step 304 to maintain the service profile.

FIG. 4 is a flowchart showing steps performed by the HSS for controlling access of network entities to child-specific information content based on access authorization data. The method is implemented, in one embodiment, by the processor 120 and/or memory 122 of the HSS 108. For convenience, the steps of FIG. 4 will be described generally as performed by the HSS 108. The steps of FIG. 4 need not be performed in the order shown.

At step 402, the HSS receives an access query from an IMS network entity. In one embodiment, the access query comprises a request for information content associated with a designated user. For example, with reference to FIG. 1, the HSS may receive an access query from AS 112 (residing within the IMS core network) or AS 116 (residing outside the IMS core network) seeking information content associated with child user 104.

At step 404, the HSS consults the child user flag associated with the designated user to determine whether the designated user is or is not a child user. If the designated user is not a child user (i.e., the query does not relate to child-specific information content), the HSS grants the IMS network entity access to the requested information content at step 408. If the designated user is a child user, the process proceeds to step 410.

At step 410, having determined that the designated user is a child user and thus the access query relates to child-specific information content, the HSS consults the access authorization data associated with the child user to determine whether the requesting network entity is allowed to access the child-specific information content. For example, the requesting network entity may be allowed to access the child-specific information content if parental consent has been obtained, or if default access has been granted to the requesting network entity and not removed by the child's parent.

At step 412, the HSS determines based on the access authorization data whether the requesting network entity is or is not authorized to access the requested content. If the requesting network entity is authorized access, the HSS grants access to the requested information content at step 414. In one embodiment, the step of granting access at step 414 comprises sending, to the requesting network entity, the child user flag along with one or more instances of the child-specific information content. It is contemplated that the child user flag will serve as a reminder to the requesting network entity, now in possession of the child-specific information content, that the child's parent must be contacted for consent before the content can be disclosed to any third party network entity. Optionally, the HSS may send parental consent data to the requesting network entity.

If the requesting network entity is not authorized access, the HSS denies access to the requested information content at step 416 (in one embodiment, by sending blank data to the requesting network entity) and notifies the parent at step 418. Thereafter, the parent may decide (or not) to update the authorization list to allow access to the requesting entity. For example and without limitation, the HSS may notify the parent with an SMS message, and the parent may reply to the SMS message with an indication to allow access to the requesting entity. Alternatively or additionally, the parent may log in to the HSS web portal to add or delete access to particular network entities.

FIGS. 1-4 and the foregoing description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. The scope of the invention is, therefore, not limited to the specific embodiments described herein, but indicated by the appended claims.

What is claimed is:

1. A method, performed by a subscriber database platform of a communication network, comprising:
identifying one or more users, including a number of child users;
maintaining service profiles for the one or more users, the service profiles including:
a child user flag identifying the child users of the one or more users;
the service profiles of the child users further including:
one or more items of child-specific information content; and
access authorization data associated with the child-specific information content; and
controlling access to the child-specific information content of respective child users based on the access authorization data.

2. The method of claim 1, performed by a Home Subscriber Server (HSS) of an IMS communication network.

3. The method of claim 1, wherein the step of identifying comprises:
maintaining birthday data associated with one or more users;
identifying the age of the users based on the birthday data;
identifying as child users, those users having an age within a designated child age threshold.

4. The method of claim 1, wherein the child-specific information content of child users includes one or more of:
child user ID;
child user birthday data;
child user parent's ID; and
child user geolocation data.

5. The method of claim 1, wherein the access authorization data comprises a list of one or more network entities authorized to access the child-specific information content associated with the respective child users.

6. The method of claim 1, wherein the access authorization data comprises a list of one or more network entities authorized based on parental consent to access the child-specific information content associated with the respective child users.

7. The method of claim 5, wherein the step of controlling access comprises:
receiving an access query initiated by a requesting network entity corresponding to a designated user;
consulting the child user flag to determine whether the designated user is a child user;
if the designated user is a child user, consulting the access authorization data to determine if the requesting network entity is authorized to access the child-specific information content associated with the designated user; and
if the requesting network entity is authorized, granting access to one or more instances of the child-specific information content; otherwise
if the requesting network entity is not authorized, denying access to the child-specific information content.

8. The method of claim 7, wherein the step of granting access comprises:
sending, to the requesting network entity, the child user flag and one or more instances of the child-specific information content.

9. The method of claim 7, wherein the step of denying access comprises:
sending, to the requesting network entity, data that does not include any child-specific information content; and
notifying the parent of the child user about the access query and the requesting network entity.

10. A method, performed by a Home Subscriber Server (HSS) of an IMS communication network, comprising:
identifying one or more IMS users, including a number of child users;
maintaining service profiles for the one or more IMS users, the service profiles including:
a child user flag identifying the child users of the one or more IMS users;
the service profiles of the child users further including:
one or more items of child-specific information content; and
access authorization data identifying one or more IMS network entities authorized to access the child-specific information content;
receiving an access query initiated by a requesting IMS network entity, the access query corresponding to a child user;
consulting the access authorization data to determine if the requesting IMS network entity is authorized to access the child-specific information content associated with the child user;
if the requesting IMS network entity is authorized, granting access to one or more instances of the child-specific information content; otherwise
if the requesting IMS network entity is not authorized, denying access to the child-specific information content.

11. The method of claim 10, wherein the access authorization data comprises a list of one or more IMS network entities authorized based on parental consent to access the child-specific information content associated with the respective child users.

12. An apparatus comprising:
a memory; and
at least one processor operably coupled to the memory and configured to:
identify one or more users of a communication network, including a number of child users;
maintain service profiles for the one or more users, the service profiles including:
a child user flag identifying the child users of the one or more users;
the service profiles of the child users further including:
one or more items of child-specific information content; and
access authorization data associated with the child-specific information content; and
control access to the child-specific information content of respective child users based on the access authorization data.

13. The apparatus of claim 12, comprising a Home Subscriber Server (HSS) of an IMS communication network.

14. The apparatus of claim 12, wherein coincident to identifying one or more users, the processor is configured to:
maintain birthday data associated with one or more users;
identify the age of the users based on the birthday data;
identify as child users, those users having an age within a designated child age threshold.

15. The apparatus of claim 12, wherein the child-specific information content of child users includes one or more of:
child user ID;
child user birthday data;
child user parent's ID; and
child user geolocation data.

16. The apparatus of claim 12, wherein the access authorization data comprises a list of one or more network entities authorized to access the child-specific information content associated with the respective child users.

17. The apparatus of claim 12, wherein the access authorization data comprises a list of one or more network entities authorized based on parental consent to access the child-specific information content associated with the respective child users.

18. The apparatus of claim 12, wherein coincident to controlling access, the processor is configured to:
receive an access query initiated by a requesting network entity corresponding to a designated user;
consult the child user flag to determine whether the designated user is a child user;
if the designated user is a child user, consult the access authorization data to determine if the requesting network entity is authorized to access the child-specific information content associated with the designated user; and
if the requesting network entity is authorized, grant access to one or more instances of the child-specific information content; otherwise
if the requesting network entity is not authorized, deny access to the child-specific information content.

19. The apparatus of claim 18, wherein coincident to granting access, the processor is configured to:
send, to the requesting network entity, the child user flag and one or more instances of the child-specific information content.

20. The apparatus of claim 18, wherein coincident to denying access, the processor is configured to:
send, to the requesting network entity, data that does not include any child-specific information content; and
notify the parent of the child user about the access query and the requesting network entity.
